(19) United States
(12) Patent Application Publication
(10) Pub. No.: US 2008/0098327 A1
(43) Pub. Date: Apr. 24, 2008

(54) Method and system for presenting information in a summarizing accordion view

(75) Inventors: Joseph Berkovitz, Cambridge, MA (US); James P. Echmalian, Arlington, MA (US); Michael G. Keirnan, Burlington, MA (US); George M. Plesko, West Roxbury, MA (US); Joseph Chung, Cambridge, MA (US); Fumi Matsumoto, Chestnut Hill, MA (US)

Correspondence Address: WILMERHALE/BOSTON, 60 STATE STREET, BOSTON, MA, 02109, US

(73) Assignee: Allurent, Inc., Cambridge, MA (US)

(21) Appl. No.: 11/903,204

(22) Filed: Sep. 20, 2007

Related U.S. Application Data
(60) Provisional application No. 60/846,267, filed on Sep. 21, 2006.

(51) Int. Cl. G06F 3/048

(52) U.S. Cl. 715/803

(57) ABSTRACT

A user interface for providing an information gateway between a user and a computer platform includes two or more windows for displaying information, and for facilitating information entry from a user. The windows may be in the form of a rectangular box, although other shapes may be used. The size and/or shape of each of the windows changes as the window content changes. The user interface requires the user sequentially step through the windows, completing the required data entry for each window before proceeding to the subsequent window. As the user encounters a particular window, that window expands to display details of the window content. When the user completes the data entry fields of an expanded window and proceeds to the subsequent window, the completed window collapses to display a summary of the content. The expansion or collapse of a window may occur in a gradual or abrupt transition.

### CROSS REFERENCE TO RELATED APPLICATIONS

This application claims benefit of U.S. Provisional Patent Application Ser. No. 60/846,267, filed Sep. 21, 2006.

### BACKGROUND OF THE INVENTION

The present invention relates to user interfaces, and more particularly, to techniques for presenting information acquired from a user during an interactive session.

In general, user interfaces allow a person to provide information to and receive information from a machine. Although user interfaces are used for wide variety of applications, probably the most well known user interfaces exist in the field of e-commerce.

Consider a consumer using a computer-based web browser to access an e-commerce website and purchase a product. The web site typically provides a user interface (typically a Graphical User Interface or GUI) that allows the consumer to review and select the product, then provide transactional information such as form of payment, shipping and billing addresses, and other such data necessary to complete the purchase.

The e-commerce user interface generally presents the consumer with a series of views to solicit this necessary transactional information. For example, once the consumer has selected the desired product or products, the user interface may present a view listing the selections and asking for confirmation. Once the consumer confirms the selections, the user interface may provide another view that requests information identifying the consumer, such as name, address, phone number, e-mail address, and the like. After entering some or all of the identifying information, the user interface may present yet another view requesting payment information. Other subsequent views may solicit additional information regarding, for example, shipping address, special handling requests (e.g., gift wrapping), requests for newsletters or advertisements, or an opportunity to continue shopping.

One problem with existing user interfaces is the possibility of the consumer getting confused or lost while navigating the sequence of views. If the user interface presents only one view at a time, the consumer may forget what information has already been entered in a previous view. Or, if the consumer does not have a particular piece of information handy when the user interface solicits that information, the consumer may skip to another view expecting to retrieve the missing information later. In this case, the consumer may have difficulty navigating back to the view with the missing information, resulting in a frustrating shopping experience.

Thus in general, existing user interfaces have deficiencies that make transactions confusing or frustrating. For example, some existing user interfaces include windows that do not provide data entry capabilities at all. These windows merely provide static content. As another example, some interfaces do not provide significant feedback regarding the content of a particular window once that window has been completed and closed or minimized. These windows may provide a title, but do not give the user insight as to specific content of the window.

Whenever a consumer encounters confusion or frustration during a transaction, that consumer may simply decide to abandon the transaction. A consumer is more likely to complete a transaction if the user interface provides a pleasant shopping experience by reducing or eliminating any perplexing or annoying situations.

### SUMMARY

A user interface is described for providing an information gateway between a user and one or more applications running on a computer platform. Although the described embodiment concerns an exemplary e-commerce application, the concepts described herein may be used for other applications that require a user-interface.

In some embodiments, the user interface includes a group of two or more windows constructed and arranged for displaying information, and for facilitating information entry from a user. The windows may be in the form of a rectangular box, although other shapes may be used. The group of windows may be associated with one another by residing within a larger “parent” window, or by relative proximity to one another, or by some other relational technique such as common color or common shape. The size and/or shape of each of the windows changes as the content of the window changes.

The user interface requires the user sequentially step through the windows, completing the required data entry or entries for each window before proceeding to the subsequent window. As the user encounters a particular window, that window expands to display details of the data entry field or fields contained therein, as well as guidance and commentary information. In general, a data entry field allows a user to provide information to the one or more applications through the user interface. The user can provide this information may in a number of ways, such as by entering alpha-numeric information through a keyboard or other data entry device, by selecting a predetermined item from (for example) a list of items, a pull-down menu or a radio button, or by other data entry techniques known in the art. When the user completes the data entry fields of an expanded window and proceeds to the subsequent window, the completed window collapses and displays a summary of the information contained therein.

In some embodiments, the expansion or collapse of a window occurs in a smooth, gradual transition. In other embodiments, the expansion/collapse of a window occurs abruptly.

In one aspect, the invention is a method of providing an interface between a user and at least one software application running on a computer platform. The method includes providing two or more windows for displaying information and for facilitating entry of information from a user. The two or more windows are visually associated with one another. The method further includes requiring the user to sequentially access the two or more windows, and for each sequentially accessed window, complete at least one predetermined data entry task before accessing a subsequent window. Each window, when sequentially accessed by the user, transitions to an expanded state to display one or more of (i) data entry fields, (ii) guidance information and (iii) commentary information. A window in the expanded state transitions to a collapsed state when the user accesses a different window, such that the window in the collapsed state displays summary information describing contents of the window in the collapsed state.

One embodiment further includes gradually transitioning from the collapsed state to the expanded state, or from the expanded state to the collapsed state. Another embodiment further includes abruptly transitioning from the collapsed state to the expanded state, or from the expanded state to the collapsed state. Yet another embodiment further includes initially providing the two or more windows in the collapsed state.

One embodiment further includes modifying one or more size characteristics of at least one of the two or more windows in response to content changes of that window. Another embodiment further includes providing data entry fields in the two or more windows, wherein the data entry fields for a particular window correspond to information required for a particular task.

One embodiment further includes providing an option to the user to allow one or more windows to remain in an expanded state when the user accesses the different window. Another embodiment further includes preventing the user from accessing the different window until data has been entered into all of the data entry fields of the expanded window. Yet another embodiment further includes automatically entering data into a first data entry field of one particular window as a result of information provided by the user to a second data entry field of the one particular window or of another window.

One embodiment further includes grouping at least two of the two or more windows to form a window group, wherein the window group has only one window open at one time with the other windows from that group remain collapsed.

In one embodiment, the summary information includes more data related to the contents in the window than a title of the window.

In another aspect, a system for providing an interface between a user and at least one software application includes a computer platform having a display for presenting the interface to the user and a processor for executing the at least one software application and for executing interface software. The system also includes a storage device for storing the at least one software application and the interface software, and for providing the at least one software application and the interface software to the processor for execution. The interface software executing on the processor is operable to provide two or more windows for displaying information and for facilitating entry of information from a user. The two or more windows are visually associated with one another. The interface software is further operable to require the user to sequentially access the two or more windows, and for each sequentially accessed window, complete at least one predetermined data entry task before accessing a subsequent window. Each window, when sequentially accessed by the user, transitions to an expanded state to display one or more of (i) data entry fields, (ii) guidance information and (iii) commentary information. A window in the expanded state transitions to a collapsed state when the user accesses a different window, such that the window in the collapsed state displays summary information describing contents of the window in the collapsed state.

In another aspect, a computer readable medium storing computer executable instructions that when executed by a computer processor are operable to provide two or more windows for displaying information and for facilitating entry of information from a user. The two or more windows are visually associated with one another. The instructions are further operable to require the user to sequentially access the two or more windows, and for each sequentially accessed window, complete at least one predetermined data entry task before accessing a subsequent window. Each window, when sequentially accessed by the user, transitions to an expanded state to display one or more of (i) data entry fields, (ii) guidance information and (iii) commentary information. A window in the expanded state transitions to a collapsed state when the user accesses a different window, such that the window in the collapsed state displays summary information describing contents of the window in the collapsed state.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1A shows one embodiment of a user interface constructed and arranged according to the invention.

FIG. 1B shows one embodiment of a computer platform for implementing the user interface of FIG. 1A.

FIG. 2 shows a state diagram for animated state transition according to an embodiment of the user interface of FIG. 1.

FIG. 3 shows an e-commerce site for which the user interface described herein may be used.

FIG. 4 shows an exemplary user interface in the e-commerce site of FIG. 3, having four inner boxes.

FIG. 5 shows the user interface of FIG. 4 with the “shipment” box expanded and the remaining boxes collapsed.

FIG. 6 shows the user interface of FIG. 4 with the “payment” box expanded and the remaining boxes collapsed.

FIG. 7 shows the user interface of FIG. 6 with feedback to the user regarding data entry.

### DESCRIPTION OF THE PREFERRED EMBODIMENTS

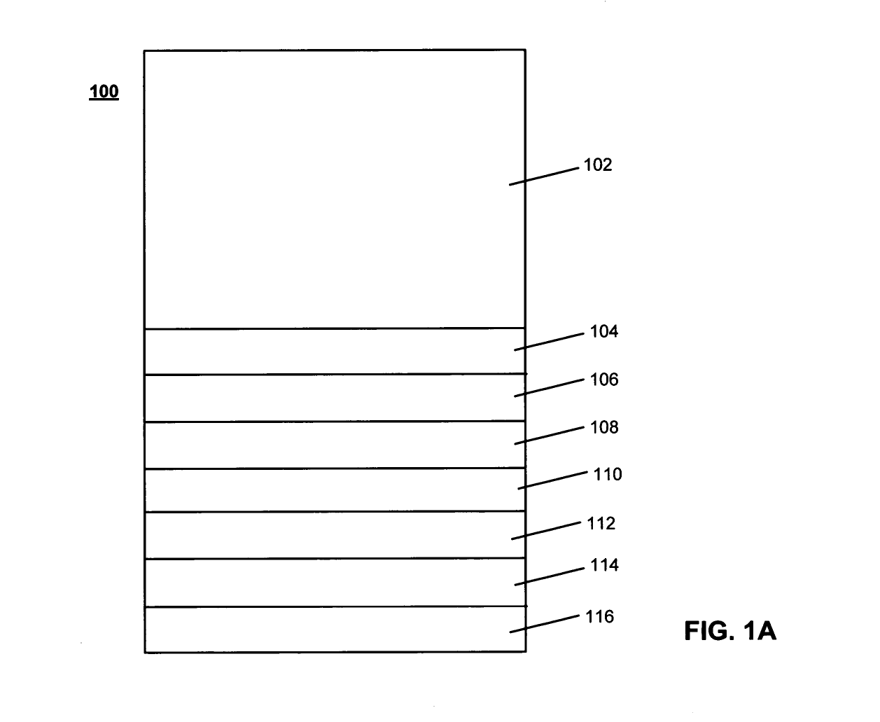

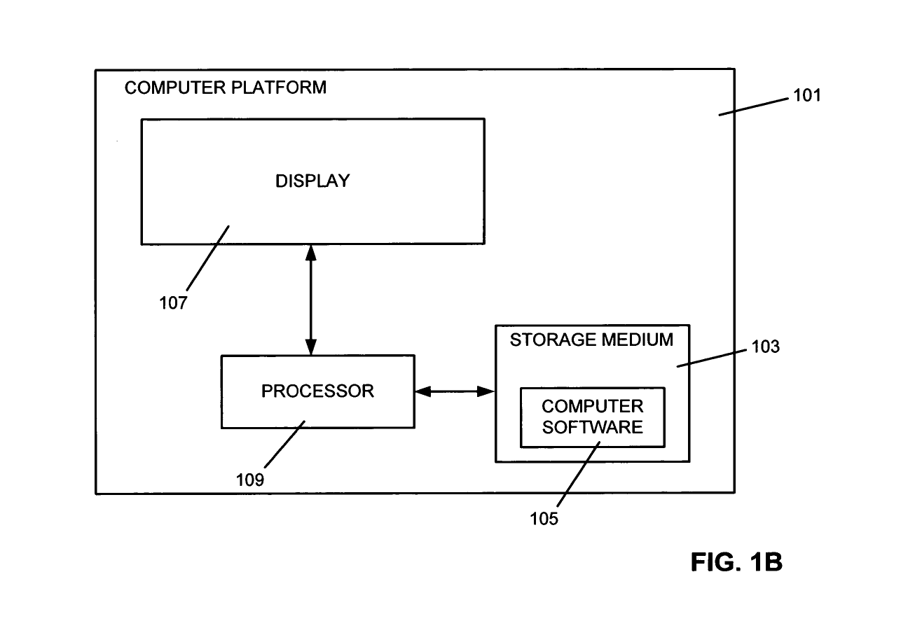

FIG. 1A shows one embodiment of a user interface constructed and arranged according to the invention. The user interface 100 presents a rectangular box 102 containing an array of smaller inner boxes 104, 106, 108, 110, 112, 114 and 116. These inner boxes, also referred to herein as “children” boxes, are stacked vertically within the parent box 102. This particular arrangement with rectangular boxes stacked vertically is merely illustrative. Other arrangements and designs are possible, with alternative box shapes and box-to-box relationships.

In the described embodiment, the user interface 100 is implemented by computer software (referred to herein as “interface software”) running or executing on a computer platform 101 as shown in FIG. 1B. The computer platform may include, for example, a stand-alone personal computer, a workstation or multiple-core computing system, although other implementation techniques known in the art may also be used. The user interface 100 provides a gateway for communication between the user and other applications running on the computer platform.

The computer platform includes a tangible storage medium 103 for storing the computer software 105. The tangible storage medium 103 may include a storage device such as a magnetic or optical disk, FLASH memory, or magnetic tape or other such storage media known in the art. In the exemplary embodiment, the storage medium 103 resides within the computer platform, but in other embodiments the storage medium 103 may be external to the computer platform.

The computer platform also includes a display 107 for presenting the user interface 100 to the user, and a processor 109 for executing the computer software 105 provided by the storage medium 103. Other components necessary for operation of the computer platform 1001, although not shown are also understood to be included.

Each of the inner boxes 104, 106, 108, 110, 112, 114 and 116 is a holder of information content. Some of the content is input provided by the user, and some of the content is native to the user interface itself. For example, the native information may include prompts or instructions that describe what information the user should enter. The native information may also include graphics (e.g., boxes, lines, spaces) that indicate where the user should enter the information. Further, some of the content may have been entered previously from the current or a different user, or some of the content may have been derived from direct user inputs. Some of the content may have been generated from the software or other type of application that is controlling, maintaining and/or utilizing the user interface 100.

In some embodiments, the portion of the box 102 that is not occupied by the smaller inner boxes also holds information as the inner boxes do.

The content of each of the inner boxes changes over the course of a user session. As their content changes, the inner boxes may expand or contract. In at least one embodiment, the inner boxes expand or contract in the vertical dimension, with the outer box 102 being anchored (i.e., stationary) at the top edge, and expanding or contracting at the bottom to accommodate the size of its children. This, however, is merely an exemplary embodiment, and other expansion/contraction schemes can alternatively be used.

In operation, the user interface 100 guides the user through a stepwise process of entering information. Each of the inner boxes 104, 106, 108, 110, 112, 114 and 116 of the user interface 100 corresponds to a particular task. An inner box is “open” while it is collecting input from the user for the corresponding task, and “closed” while awaiting the user's attention or presenting summary information to the user. In some embodiments, while a particular inner box is open, rest of the inner boxes are closed, although in other embodiments more than one box may be open.

In at least one embodiment, the stepwise process described above requires the user to complete all of the required input actions for a particular box before the user can proceed to the subsequent box. In general, the user cannot complete only a portion of a box, expecting to return to that box at a later time.

In some embodiments, an “accordion” component of the user interface 100 provides for opening one inner box at a time, which keeps the user focused on the task at hand. When the user completes one step in the process, the accordion component closes the open box as it opens a new one. In the described embodiment, visual transitions between open and closed state smoothly animated. In other words, as an inner box transitions from open to closed (or closed to open), the size of the box changes gradually. The effect is a seamless flow from one logical step of the process to the next.

In some embodiments, the user interface 100 includes groups of related boxes, so that one box from each “group” can be open at a time, with other boxes from that group closed. A group of related boxes may have a relationship or link to one or more of the other groups, although such a relationship or link is not necessary.

A “summarizing accordion” transition provides the visual transition described above, but also provides a summary view of the contents of the inner box once it is closed. In other words, once the inner box is closed it only displays a summary of the content contained within. This summary view of the inner box contents may be displayed without the accordion transition described above.

The following sections describe implementation details of the user interface 100 described above. This particular implementation is only one example of how the user interface 100 may be carried out, and is not intended to be limiting.

Object Framework

The internal framework for this user interface is made up of three abstract component classes, (i) TaskSequence, (ii) Task, and (iii) TaskView. The responsibilities of each class are shown in the table below.

| Class Name | Responsibility |
|---|---|
| TaskSequence | Represents the accordion control as a whole. |
| | Manages its array of Task children. |
| Task | Represents an inner box within the accordion |
| | control. Communicates state changes to its |
| | parent TaskSequence. Manages a set of |
| | TaskView children, only |
| | one of which may be shown at a time. |
| TaskView | Represents one possible view of a Task. |

A TaskSequence has the properties shown in the table below.

| Property | |
|---|---|
| Name | Meaning |
| complete | Becomes true when the user completes all |
| | Tasks in the sequence. |
| openTask | A reference to the Task child that is |
| | currently open. If all Tasks are closed, |
| | is empty (null). |

A Task has the properties shown in the table below.

| Property | |
|---|---|
| Name | Meaning |
| complete | If false, the task requires user interaction before |
| | the sequence can advance to the next task. |
| open | If true, the task is showing its open view. |
| | If false, the task is showing its closed view. |
| | Only the parent TaskSequence may modify this |
| | property. |
| openView | The TaskView to be shown if the Task is open. |
| closedView | The TaskView to be shown if the Task is closed. |
| currentView | The TaskView to be shown currently. |

The TaskSequence maintains the following invariants in management of its Task children:
(1) At most one of its Task children may be open at any time;
(2) The openTask may not be later in the sequence than the earliest incomplete Task. Completeness of a Task is not absolute; once a Task becomes complete, if the state of the application changes in such a way as to render the Task incomplete, the TaskSequence must respond by updating its display, enforcing the second invariant.
   State Transitions

The TaskSequence receives notification of any event that may require its display to change, including:

(1) A change in the complete property of any child Task;

(2) A change in the openView property of any child Task;

(3) A change in the closedView property of any child Task;

(4) A user request to open a specific Task;

(5) A user request to close the open Task;

(6) The addition of a new Task to the list of children;

(7) The removal of a child Task.

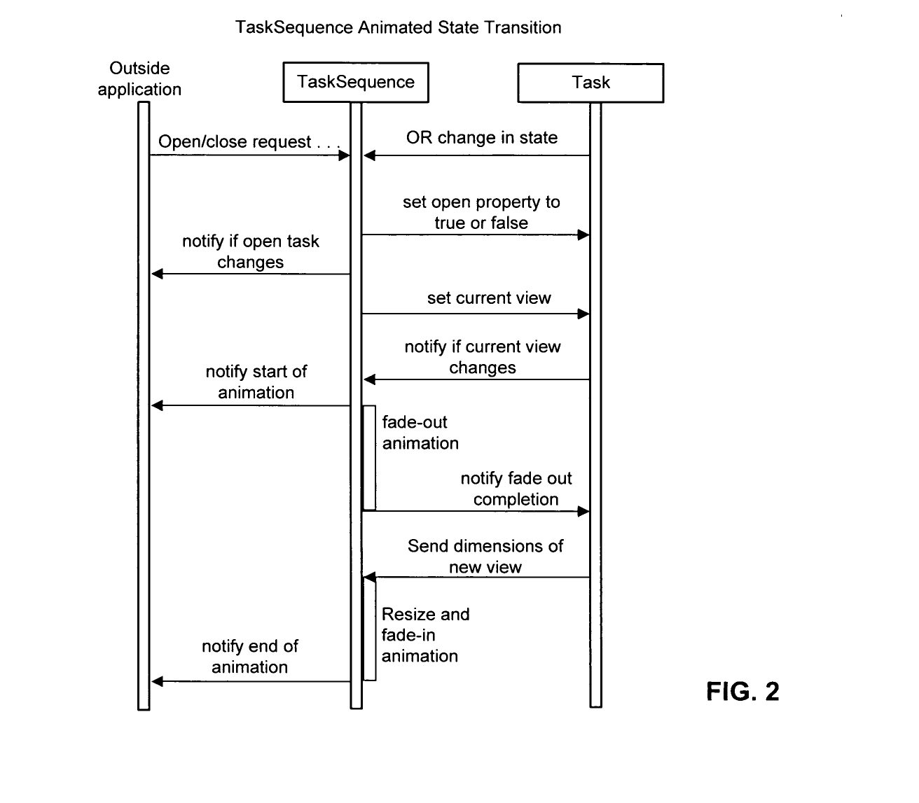

The TaskSequence responds to notification by re-evaluating its open task, then assigning to each child Task either its openView or closedView, depending on whether it is open or closed. If the currentView of any child Task has changed, the TaskSequence mediates an animation sequence that brings all new TaskViews into view and resizes the entire display accordingly. The sequence of events is as illustrated in FIG. 2.

Alternatively, the TaskSequence may only assign a view to the two TaskViews that are affected, while leaving the other TaskViews alone.

In the transition diagram of FIG. 2, the messages between the TaskSequence and Task are parallel, with one message sent or received per Task in transition. Setting the current view does not effect an immediate change in the display.

As described above, the TaskSequence and Tasks are responsible for dispatching state change events to other objects, allowing the outside application to respond interactively to changes in the sequence.

Application to Checkout

The summarizing accordion view is a specialization of the framework described above. The specialization adds the following logic to the framework.
(1) At start time, the application initializes the closedView of each Task to a simple display that indicates that the Task has not yet been completed. The openView of each Task is not yet set.
(2) When a Task signals that it is opening, the application assigns it an openView based on the application state. For example, if a pre-registered user advances to the “payment information” task, the task presents a view that includes options that would not be available to a non-registered user. The view shown depends on the application state.
(3) When the user enters information for a particular Task, the application assigns the Task a closedView that displays a summary of the information the user entered. For example, once the user has entered payment information, the closed “payment information” task shows a summary of the payment information.

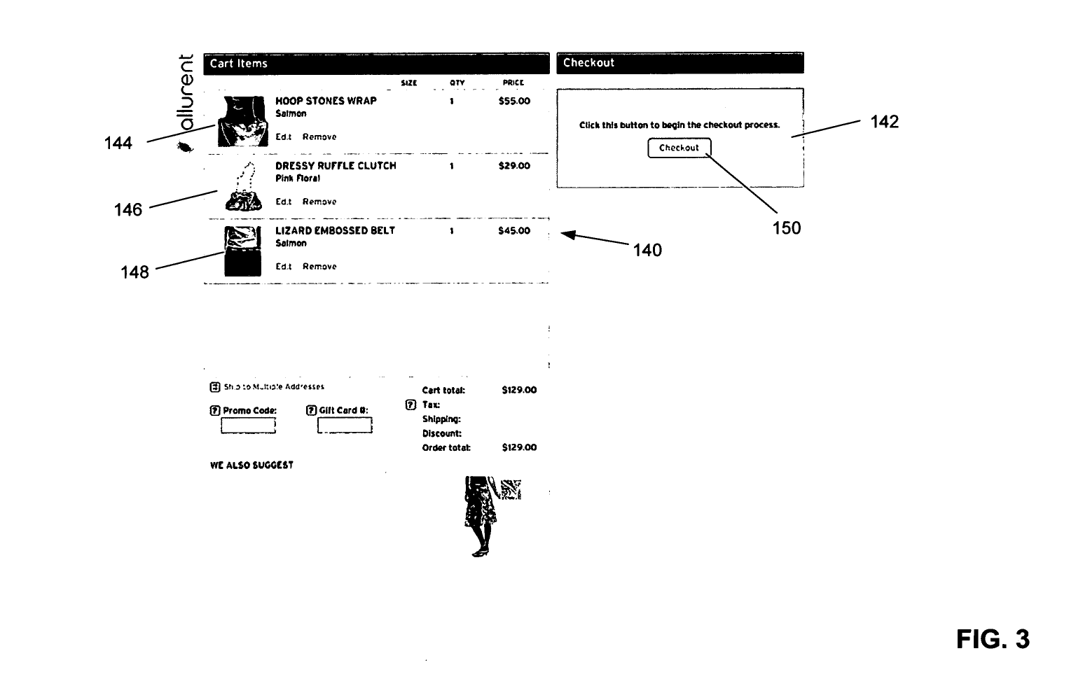

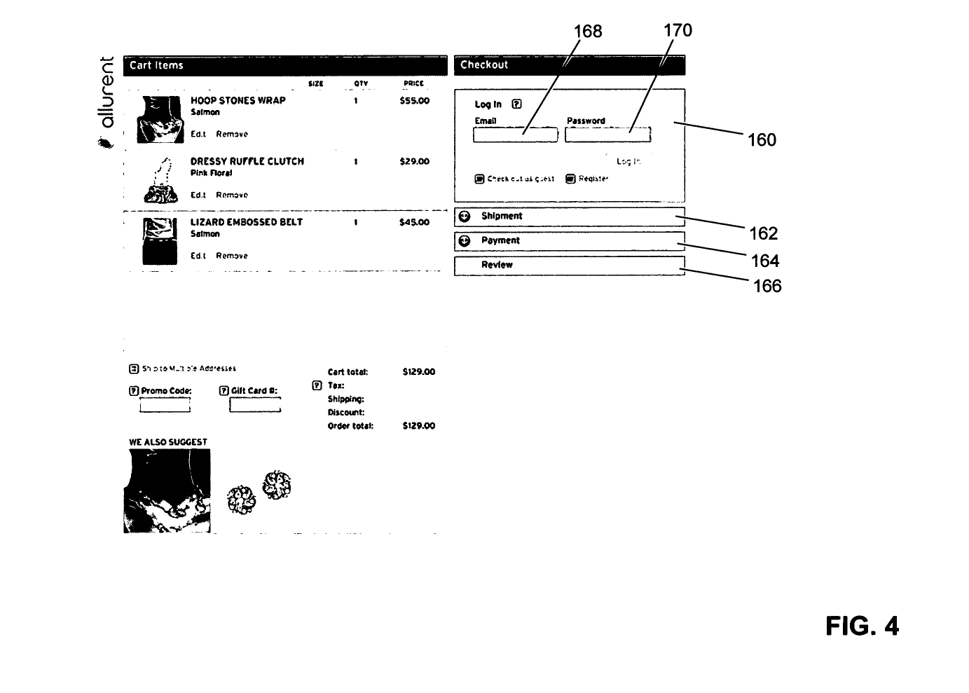

FIG. 3 shows another embodiment of a user interface 100 as described herein. FIG. 3 shows an e-commerce site with a “shopping cart” area 140 and a “checkout” area 142. In FIG. 3, the user has selected several items 144, 146 and 148, which are shown in the cart area 140. Once the user is finished shopping, the user selects the “checkout” button 150 in the checkout area 142, resulting in the view shown in FIG. 4.

FIG. 4 shows four “inner boxes” as described above; a login box 160, a shipment box 162, a payment box 164, and a review box 166. In this embodiment, there is no “parent” box containing several inner boxes, but rather four separate boxes corresponding to the “inner” boxes described above.

As each of the boxes in FIG. 4 is opened, it expands to show detailed data entry items such as “email” 168 and “password” 170 in the login box 160, while the other boxes remain small with only title information displayed.

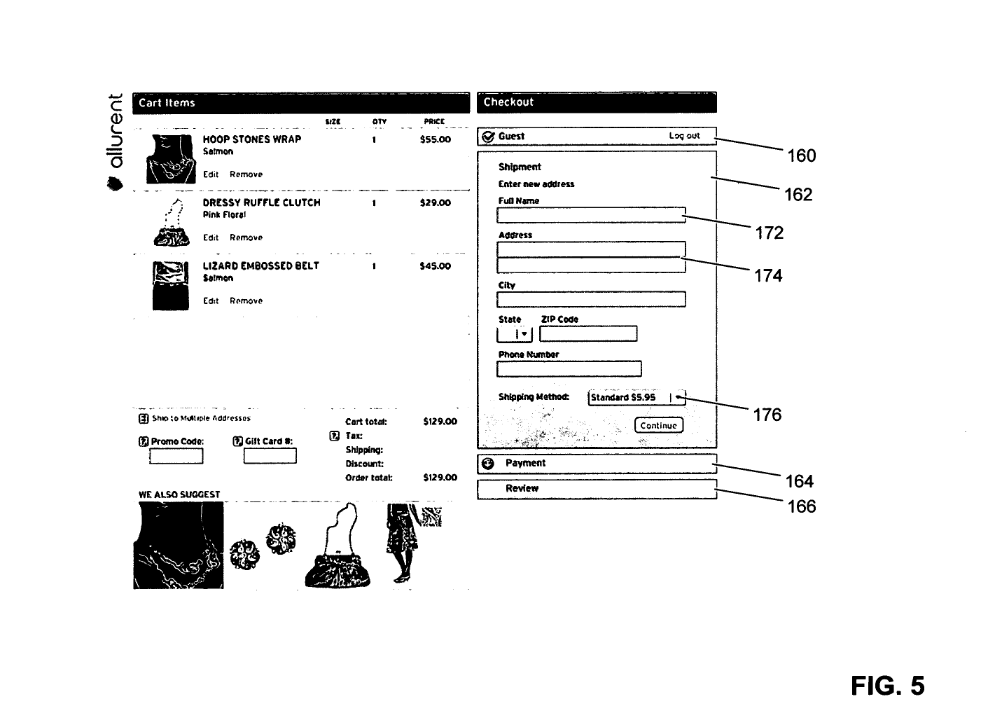

Once logged in, the shipment box 162 opens as shown in FIG. 5, while the login box 160 becomes the logout box. When open, the shipment box 162 expands to show a number of entry items, such as name 172, shipping address 174 and shipping method 176.

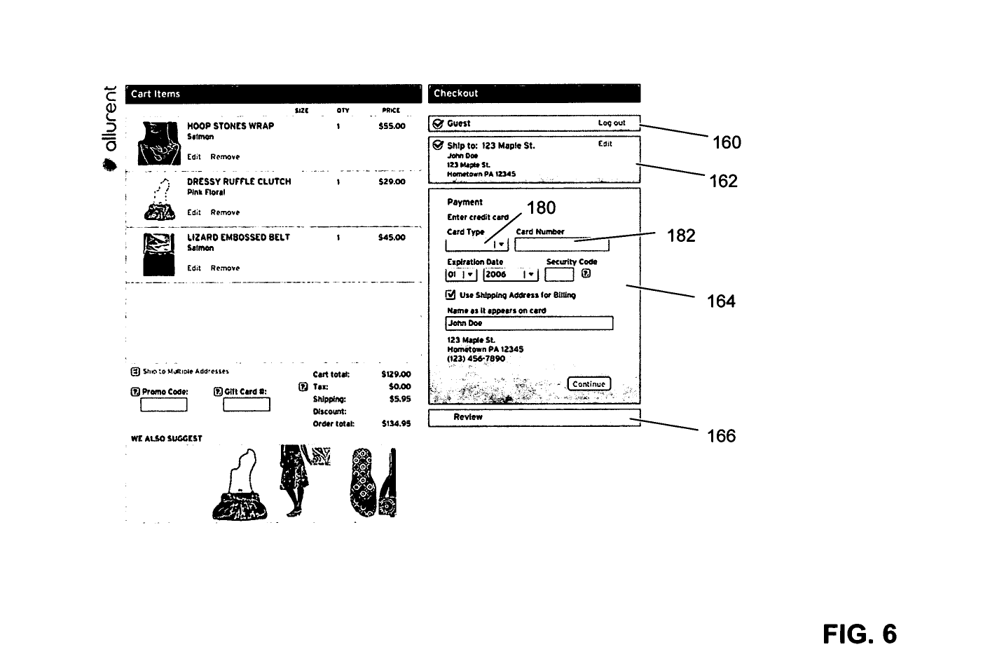

After the user enters all of the data required for the shipment box 162, the shipment box 162 collapses and the payment box 164 expands, as shown in FIG. 6. As shown, the collapsed shipment box 162 now displays a summary of the information entered in the step corresponding to FIG. 5. The user now completes the entry items in the open payment box shown in FIG. 6, such as credit card type 180 and credit card number 182.

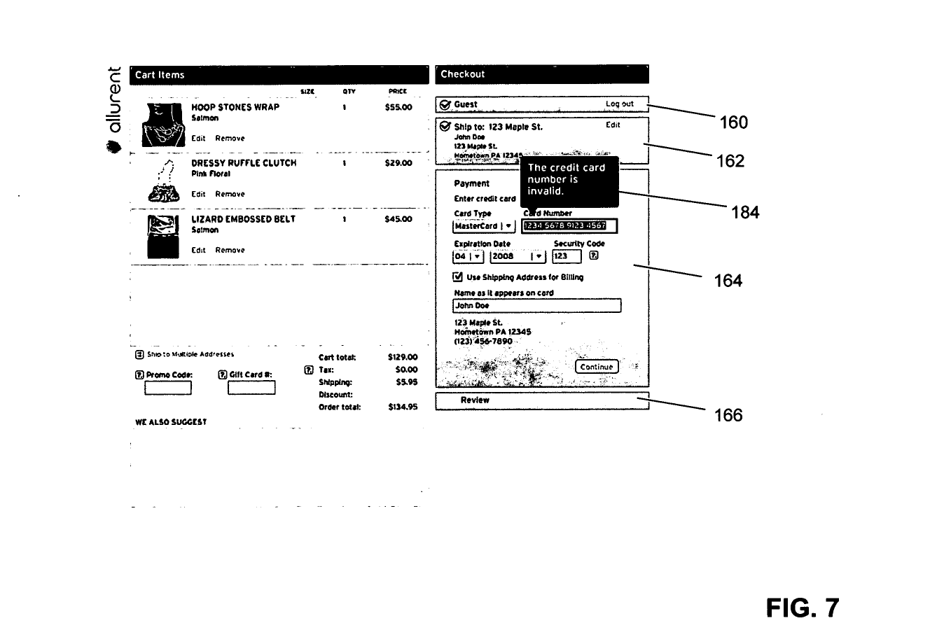

FIG. 7 shows how an expanded box 164 can provide guidance to the user when the user interface receives an unexpected input. In FIG. 7, the user has entered an invalid credit card number. The user interface provides a message 184 to the user specifically pointing out where the error occurred.

The invention may be embodied in other specific forms without departing from the spirit or essential characteristics thereof. The present embodiments are therefore to be considered in respects as illustrative and not restrictive.

What is claimed is:

1. A method of providing an interface between a user and at least one software application running on a computer platform, comprising:
providing two or more windows for displaying information and for facilitating entry of information from a user, wherein the two or more windows are visually associated with one another;
requiring the user to sequentially access the two or more windows, and for each sequentially accessed window, complete at least one predetermined data entry task before accessing a subsequent window;
wherein each window, when sequentially accessed by the user, transitions to an expanded state to display one or more of (i) data entry fields, (ii) guidance information and (iii) commentary information; and,
wherein a window in the expanded state transitions to a collapsed state when the user accesses a different window, such that the window in the collapsed state displays summary information describing contents of the window in the collapsed state.

2. The method of claim 1, further including gradually transitioning from the collapsed state to the expanded state, or from the expanded state to the collapsed state.

3. The method of claim 1, further including abruptly transitioning from the collapsed state to the expanded state, or from the expanded state to the collapsed state.

4. The method of claim 1, further including initially providing the two or more windows in the collapsed state.

5. The method of claim 1, further including modifying one or more size characteristics of at least one of the two or more windows in response to content changes of that window.

6. The method of claim 1, further including providing data entry fields in the two or more windows, wherein the data entry fields for a particular window correspond to information required for a particular task.

7. The method of claim 1, further including providing an option to the user to allow one or more windows to remain in an expanded state when the user accesses the different window.

8. The method of claim 1, further including preventing the user from accessing the different window until data has been entered into all of the data entry fields of the expanded window.

9. The method of claim 1, further including automatically entering data into a first data entry field of one particular window as a result of information provided by the user to a second data entry field of the one particular window or of another window.

10. The method of claim 1, further including grouping at least two of the two or more windows to form a window group, wherein the window group has only one window open at one time with the other windows from that group remain collapsed.

11. The method of claim 1, wherein the summary information includes more data related to the contents in the window than a title of the window.

12. A system for providing an interface between a user and at least one software application, comprising:
a computer platform including a display for presenting the interface to the user and a processor for executing the at least one software application and for executing interface software;
a storage device for storing the at least one software application and the interface software, and for providing the at least one software application and the interface software to the processor for execution;
wherein the interface software executing on the processor is operable to:
provide two or more windows for displaying information and for facilitating entry of information from a user, wherein the two or more windows are visually associated with one another;
require the user to sequentially access the two or more windows, and for each sequentially accessed window, complete at least one predetermined data entry task before accessing a subsequent window;
wherein each window, when sequentially accessed by the user, transitions to an expanded state to display one or more of (i) data entry fields, (ii) guidance information and (iii) commentary information; and,
wherein a window in the expanded state transitions to a collapsed state when the user accesses a different window, such that the window in the collapsed state displays summary information describing contents of the window in the collapsed state.

13. The system of claim 12, wherein the window in the expanded state gradually transitions from the collapsed state to the expanded state, or from the expanded state to the collapsed state.

14. The system of claim 12, wherein the window in the expanded state abruptly transitions from the collapsed state to the expanded state, or from the expanded state to the collapsed state.

15. The system of claim 12, wherein the two or more windows are initially provided in the collapsed state.

16. The system of claim 12, wherein one or more size characteristics of at least one of the two or more windows are modified in response to content changes of that window.

17. The system of claim 12, wherein at least one data entry field is provided in the two or more windows, such that the data entry fields for a particular window correspond to information required for a particular task.

18. The system of claim 12, wherein an option is provided to the user to allow one or more windows to remain in an expanded state when the user accesses the different window.

19. The system of claim 12, wherein the user is prevented from accessing the different window until data has been entered into all of the data entry fields of the expanded window.

20. The system of claim 12, wherein data is automatically entered into a first data entry field of one particular window as a result of information provided by the user to a second data entry field of the one particular window or of another window.

21. The system of claim 12, wherein at least two of the two or more windows is grouped to form a window group, wherein the window group has only one window open at one time with the other windows from that group remain collapsed.

22. A computer readable medium storing computer executable instructions that when executed by a computer processor are operable to perform the steps comprising:
providing two or more windows for displaying information and for facilitating entry of information from a user, wherein the two or more windows are visually associated with one another;
requiring the user to sequentially access the two or more windows, and for each sequentially accessed window, complete at least one predetermined data entry task before accessing a subsequent window;
wherein each window, when sequentially accessed by the user, transitions to an expanded state to display one or more of (i) data entry fields, (ii) guidance information and (iii) commentary information; and,
wherein a window in the expanded state transitions to a collapsed state when the user accesses a different window, such that the window in the collapsed state displays summary information describing contents of the window in the collapsed state.
